(19) United States
(12) Patent Application Publication
(10) Pub. No.: US 2010/0152892 A1
(43) Pub. Date: Jun. 17, 2010

(54) Device for displaying articles for sale, particularly flowers

(75) Inventors: Yair Gavra, Givat Shmuel (IL); Shimon Prisant, Caesaria (IL); Josef Gilstron, Kiryat Haim (IL); Alexander Lavie, Kiryat Haim (IL); Mahmoud Massri, Jedayda-Makker (IL)

Correspondence Address: ROBERT G. LEV, 4766 MICHIGAN BLVD., YOUNGSTOWN, OH, 44505, US

(73) Assignee: Pirchei Hanamal Ltd., Ben-Gurion Airport (IL)

(21) Appl. No.: 12/590,768

(22) Filed: Nov. 13, 2009

(30) Foreign Application Priority Data
Nov. 16, 2008 (IL) 195318

(51) Int. Cl. G07F 11/62; A47F 3/10; G06F 17/00

(52) U.S. Cl. 700/232; 312/115

(57) ABSTRACT

Embodiments of the present invention relate to display devices for displaying cut flowers pivotally mounted with respect to a transparent display case. The display device comprises a drum and a container for an aqueous liquid therewithin. Additional embodiments of the present invention relate to vending machines comprising the display devices.

### PRIORITY INFORMATION

The present invention claims priority to Israeli Provisional Patent Application No. 195318 filed on Nov. 16, 2008, making reference to same herein, in its entirety.

### FIELD OF THE INVENTION

The present invention relates to a display device, typically for incorporation within a vending machine, particularly but not exclusively for vending bouquets of cut flowers and the like.

### BACKGROUND OF THE INVENTION

Vending machines or automats, as they are sometimes known, are widely used for providing snack foods, newspapers, prophylactics, video films or DVDs, cigarettes and the like.

One advantage of vending machines is that they can be situated at strategic locations and operate 24 hours a day, 7 days a week, and deal with low sales volumes that do not make providing a human vendor economically feasible.

Vending machines for vending one item selected from identical, standard articles may be very simple. A vending machine for newspapers typically requires insertion of a coin to open a vending door, and since people rarely want more than one paper, and in a busy area, such as at the entrance to subways and the like, someone taking a plurality of papers would be noticed and chastised, such machines often allow the purchaser to take more than one paper, relying on the good will of purchasers to take one paper only. Indeed the main reason for a newspaper vending machine to include a window at all, is for the customer to assure himself that the machine is not empty. An additional reason for including a window is to allow display of the newspaper headlines.

Vending machines for dispensing cans of soft-drinks, chocolate, condoms and the like, typically display the logo of the products contained therein on the outside thereof. A mechanism is required to refund money if the selected item is unavailable, and, sometimes an indicator is provided to indicate that the selected goods are sold out.

Where the physical appearance of the item to be sold is important, but there is still a high level of standardization, such as for croissants and sandwiches, it is useful for the vending machine to include a window to allow viewing of the items therewithin. Typically, the items are arranged in rows or shelf elements and each item within the row or shelf element is substantially identical. A forwarding means is required to move each item along, so that as one item is vended, by being placed opposite a vending port, for example, the next item is brought up into its place.

Sometimes, items to be vended are arranged on a carousel and it will be appreciated that where the vendible items in each row are substantially identical, it does not much matter which vendible item is dispensed and one such item may be aligned with a port behind a locked door, and on payment, the door is opened and the purchased item extracted. There is no need to rotate the row of vendible items other than to bring a second item into alignment with the port. All that is required is for the vending machine to advance the products after removing one, and the mechanism for closing the door may achieve this, thus where each row of articles sits on a carousel, and there are 12 items per row, closing the door may advance the row 30°.

Although the items in each row are typically substantially similar, the different rows may, and often do contain different items from each other. Thus a sandwich vending machine may have sandwiches containing different fillings in each row. Likewise, a snack vending machine may have sandwiches in one row, and cakes, candy bars or other snack food in other rows.

For vending individual goods perceived as having product differentiation by the customer, and particularly where such goods are have a short shelf element-life, vending machines are not ideal, and manned stores may be more appropriate. For some locations with irregular hours and small turnovers this may be impractical, and even small kiosks generally require more room than vending machines.

Cut flowers have limited shelf element life and require carefully controlled conditions. Simple vending machines are thus unsuitable for storing and selling cut flowers, but a number of specially designed flower dispensing automats are known.

International Patent Publication No. WO05043474 entitled “Automatic Vending Equipment For Selling Long-Shaped Objects, Especially Flowers” and incorporated herein by reference, relates to automatic vending equipment which include a house that encases a storage space, a control and feeding part unit placed in the house, a moving part unit and a storage unit connected to the moving part unit, the storage unit has a bearing axle placed in the house in a rotatable way and one or more shelf element-structures attached to the bearing axle, and the shelf element-structure is divided into compartments with the help of guiding elements. A characteristic feature of the equipment is that at least a part of the compartments have a penetrable receiving space along the bordering surface of the bearing axle, at least a part of the main axes of the receiving spaces belonging to the individual compartments, and the longitudinal axis of the bearing axle are out of line.

Korean patent application number Korean patent application number KR1068901 entitled “Flower Vase Vending Machine”, incorporated herein by reference, serves for conveniently providing various kinds of flower vases to consumers, meeting the various consumer tastes. The machine is characterized by when a consumer pushes a selection button, a withdrawing means is rotated so that a plate, installed movably at the lower part of a flower vase receiving chamber for preventing discharge of the flower vase, is opened. Right after discharging the flower vase corresponding to cash input, a solenoid valve regulates an interrupter to exactly control the number of flower vase to be vented. In the case that the bottom side of a casing is closed with upwardly drawing the plate the solenoid valve operated by electric force draws the interrupter so that the flower vase is placed between the interrupter and the plate for the next vend.

U.S. Pat. No. 7,086,198 entitled “Machine For Vending Floral Arrangements” relates to a machine for vending floral arrangements that includes a stack of generally circular carousels each for supporting a plurality of floral arrangements; and a generally cylindrical exterior housing surrounding the carousels.

United Kingdom Patent Number GB2401102, entitled “A Machine for Vending Floral Arrangements”, incorporated herein by reference, relates to a machine for vending floral arrangements comprises a stack of circular carousels, each for supporting a plurality of floral arrangements. The machine has a generally circular exterior formed by the exteriors of a plurality of stacked modules. Each module houses a carousel in the form of a rotary shelf element, the housing may also comprise a dome and a base. In order to maintain the flowers therein, the housing may be substantially air tight and includes a refrigeration coil. Viewing windows and display lighting may be used to reduce ingress of external light.

European Patent Number EP0710936 entitled “Vending Machine for Cut Flowers”, incorporated herein by reference, describes a retail furnishing for cut flowers that has a cooled housing in which a turret with holders is arranged. Each holder has a plurality of compartments placed one above another which are each provided with a reservoir for water for the flowers. The purchaser can bring the desired compartment behind a removal opening by operating keys. The removal opening can be unlocked by inserting coins of appropriate value. Because only one compartment is accessible, the possibility of fraud is minimized.

### SUMMARY OF THE INVENTION

There is a need for a low maintenance vending machine for frangible items such as cut flowers and the like, that provides an extended shelf element-life and that displays the flowers to their best advantage. It is one object of the present invention to provide such a machine.

A first aspect of the present invention is directed to providing a display device for displaying cut flowers within a transparent display case, the display device being pivotally mounted with respect to the case, to allow the drum to rotate about it's axis with respect to the display case; the display device including a drum having a first row of apertures therearound and a container for an aqueous liquid therewithin, below the first row of apertures so that stems of cut flowers passing through the apertures are insertable into the container to slant upwards and outwards towards the display case.

Typically, the drum further includes at least one additional row of apertures and associated container for displaying cut flowers in a plurality of rows.

Typically, the display device of claim 1 wherein the display case includes a window including a material selected from the list of silica glass and glassy thermoplastics.

Typically, the display device includes a plurality of display niches arranged about the drum, within the display case, each niche having an aperture associated therewith, so that at least one cut flower can be positioned within each niche and, so that stem passes through aperture into container, and head of at the at least one cut flower is viewable through the display case.

Preferably, the vertical side wall elements of the niches are arranged radially around the drum.

Preferably, the bases of the niches are shelf elements that slope outwards and upwards from the drum.

Preferred embodiments further include a circulating system for circulating the aqueous liquid.

Optionally, the circulating system includes a reservoir at base of the display device, a pump for pumping fluid from the reservoir to the uppermost container via a conduit, and overflow pipes coupled to each container, for maintaining the liquid level in each container, and diverting excess liquid to container therebeneath.

A second aspect of the invention is directed to providing a vending machine including the display device described hereinabove within the display case and further including a port associated with each row of niches for accessing niches within each row for removing vendible goods thereby.

Typically, the ports include selectively lockable doors to prevent access to contents of the niches.

Typically, the vending machine further includes a user interface for selecting a niche to bring the niche into alignment with a port for extraction of contents thereby.

Optionally, the user interface further includes a payment means and allows selection of a niche only after making a payment.

Typically, the payment means being selected from the group including a credit card reader and a cash depositing system.

Typically, the interface includes an alphanumeric keypad for keying in data and a screen for displaying data to user. These may be combined in a touch-sensitive screen.

Preferably, the interface allows selection of a message for displaying on a card for accompanying the vendible article.

Optionally, the interface allows personalizing the message for displaying on a card for accompanying the vendible article.

Typically, the vending machine further includes a mechanism for rotating the display device with respect to the display case. Typically, the mechanism includes an electrical motor and a transmission coupled to the drum.

Preferably, the vending machine further includes refrigeration means.

Preferably, the vending machine further includes illumination means.

### BRIEF DESCRIPTION OF THE DRAWINGS

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. Consistent numbering is used throughout. In the accompanying drawings:

FIG. 1 is a schematic front view of a vending machine in accordance with one embodiment of the invention;

FIG. 2 shows the display case of the vending machine, with niches for cut flowers, particularly for bouquets arranged behind the window of the display case, around a central drum;

FIG. 3 shows a cylindrical arrangement of niches arranged around the central drum;

FIG. 4a is an isometric projection of a drum in accordance with one embodiment;

FIG. 4b is a plan view of a slat for coupling to the drum of FIG. 4a, to radiate there-outwards, to form vertical side wall elements of niches;

FIG. 4c is an isometric projection of a base piece for engaging the slat and forming a sloping base for the niches;

FIG. 5 shows the arrangement of the side and base wall elements, the axle and containers, with drum removed for clarity, and

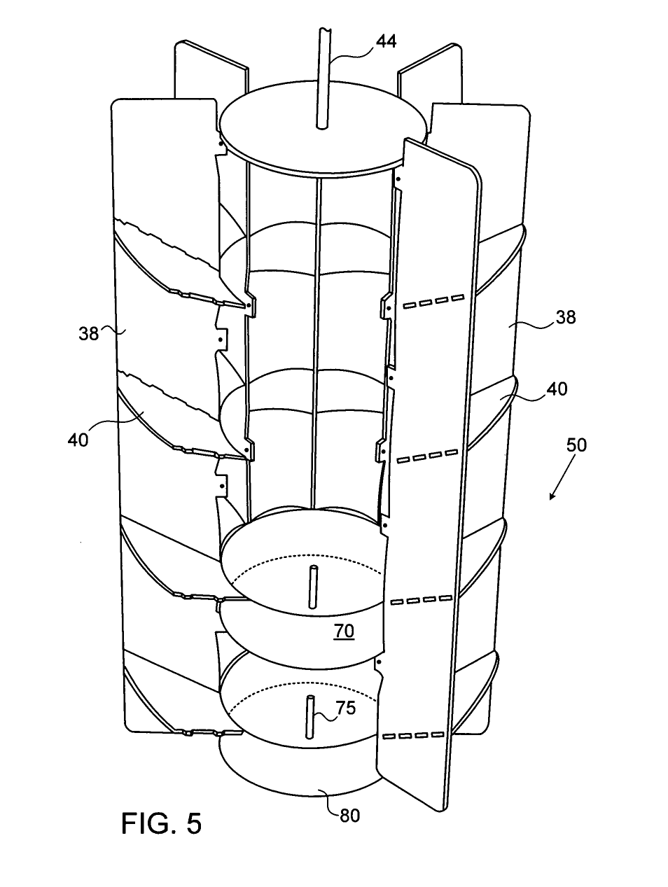

FIG. 6 is a schematic cross-sectional partial side view of the display device of the invention, showing the re-circulating liquid nutrient system of a preferred embodiment.

### DESCRIPTION OF THE PREFERRED EMBODIMENTS

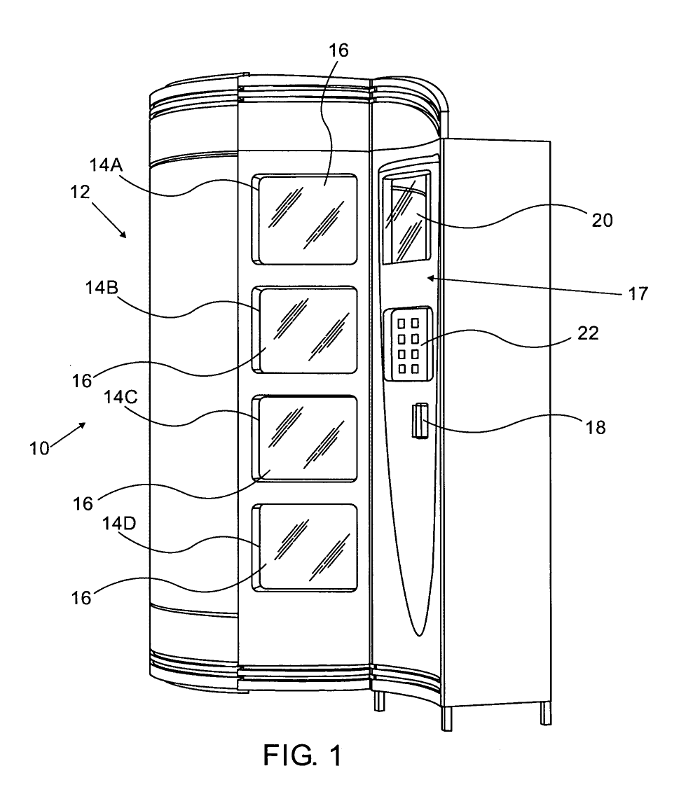

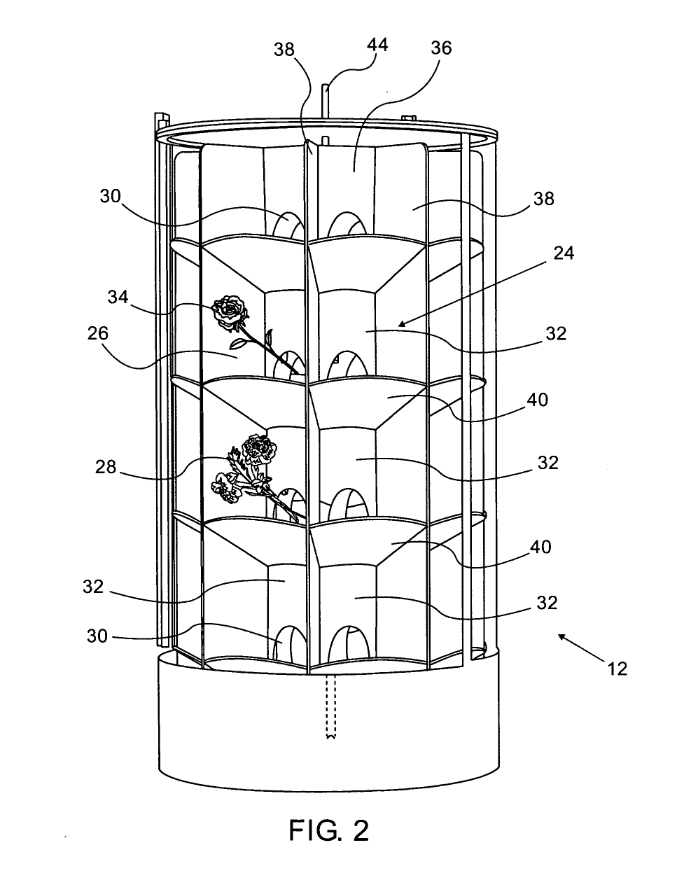

With reference to FIG. 1, a vending machine 10 in accordance with one embodiment of the invention is shown. Vending machine 10 consists of a display case 12 which is generally a section of a cylinder, within which vendible articles, typically bouquets of flowers are displayed. The vendible items sit on a carousel (See FIG. 2). Vending machine 10 includes ports 14A-14D associated with each row of vendible articles for extracting the vendible articles thereby. Usually, the ports 14A-D are closed by selectively lockable doors 16 that, when closed, prevent access to vendible articles. Lockable doors may be transparent or opaque. If a vendible good is aligned with a specific port 14A and the door 16A is opened, the vendible good may be extracted.

A particular application of preferred embodiments of the present invention is for vending cut flowers, or bouquets of flowers and perhaps wreaths, or posies or even pot-plants. In such applications, the purchaser may wish to select a particular bouquet. Even if each bouquet in a row is substantially identical, the purchaser will typically want to select the bouquet to be purchased, and it is a particular feature of preferred embodiments of the invention that, as with purchasing from street vendors or flower shops, the purchaser may select and purchase a particular bouquet by keying in the code of the niche containing the bouquet. It will be appreciated that vending machines for cut flowers should preferably display each bouquet to its best advantage, and typically they will be arranged in a carousel or similar, within the display case 12 and a mechanism is provided to slowly rotate the carousels to allow each bouquet to be viewed to best advantage. To select a desired article, a user interface 17 is provided. This may include a payment means such as a credit card reader 18 and/or a cash depositing system, a screen 20 for displaying data to user and an alphanumeric keypad 22 for keying in data to select specific bouquet by niche thereof. In some embodiments, the interface allows selection of a message or graphic for displaying on a card for accompanying the cut flowers and some embodiments may allow personalizing the message for displaying on a card for accompanying said cut flowers.

FIG. 2 shows the display case 12 of the vending machine 10 of FIG. 1 in more detail. Niches 24 are provided for the vendible items. To facilitate the provision of water or other liquid nutrition to the single blooms 26 or, preferably, to bouquets 28, usefully apertures 30 are provided in the back wall element 32 of the niches 24. In this manner, the flower heads 34 face outwards and are displayed to their best advantage, and the cut ends of the flowers may be inserted through apertures 30 into a liquid nutrition medium, as shown and described in detail, hereinbelow. Typically, the niches are arranged around a drum, with the back-wall elements 32 of the niches 24 being defined by an outward-facing surface of the drum 36, which may be cylindrical or polygonal in shape. Wall elements 38, angled shelf elements 40, which define the bases and tops of the niches 24 are connected to the drum 36 and are located in close proximity to, but do not touch the display case. The display case may be fabricated from a clear plastic such as poly-methyl methacrylate or, preferably polycarbonate, which has a higher resistance to scratching. Glass is preferred in terms of scratchproof properties; it is preferably toughened by heat treatment.

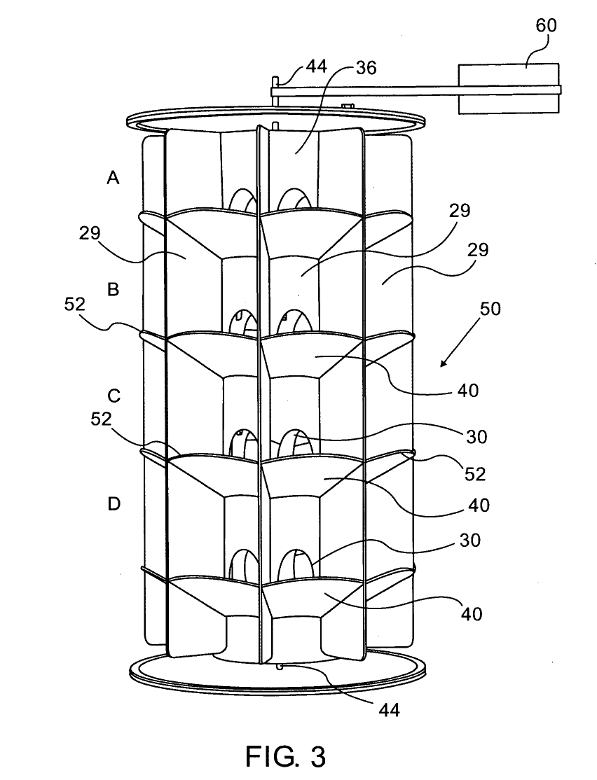

By rotating the drum 36 with respect to the display case 12, the contents of the niches 24 may be displayed, and an axle 44 is provided about which the device 50 (FIG. 3) may be rotated by a motor, shown schematically at 60 (FIG. 3), either continuously, or step wise, bringing each column of niches 24 into view, pausing and then continuing to rotate. The side wall elements 38 and shelf elements 40 of the niches 24 may be transparent or mirrored to display the contents to best advantage. The back-wall element 32, i.e. the outer surface of the inner drum 36, is typically opaque and may be mirrored. It will be appreciated that cut flowers 28, 34 are not particularly heavy, and the display device 40 consisting of the drum 36 and niches 24 thereabout, may usefully be fabricated from lightweight materials such as plastics and aluminum.

Optionally, the display windows of the display case 10 may be hinged along one edge to allow them to be opened outwards for maintenance and particularly to facilitate their cleaning on the inside.

FIG. 3 shows the display device 50 consisting of a cylindrical arrangement of niches 24 arranged around the central drum 36 in more detail. It will be noted that the shelf elements 40 of the niches 24 are oriented generally outwards and upwards with respect to apertures 30. The vertical wall elements 38 of the niches 24 may be common to all niches 24 in a column. The front edges 52 of the shelf elements 40 will typically by arcuate to come into close proximity with the display case 12 thereabout. The back wall element 32 of each niche 24 may be curved or flat, with the inner drum 36 having a cylindrical or polygonal cross section.

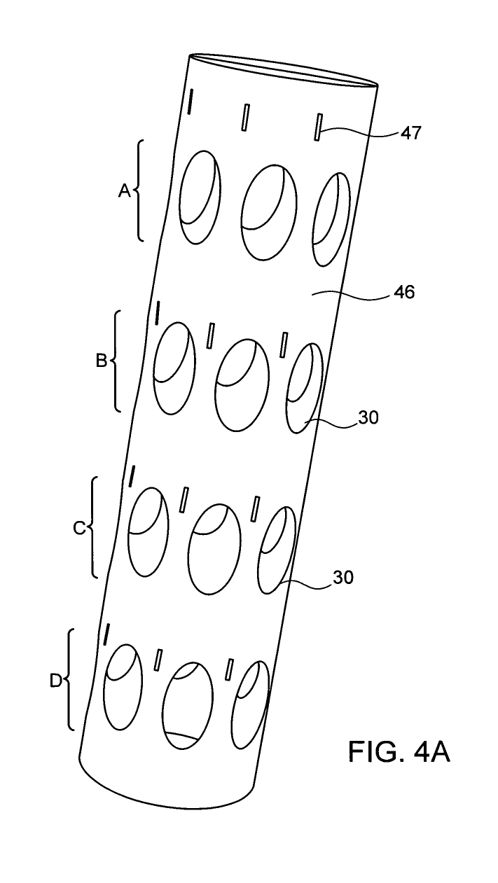

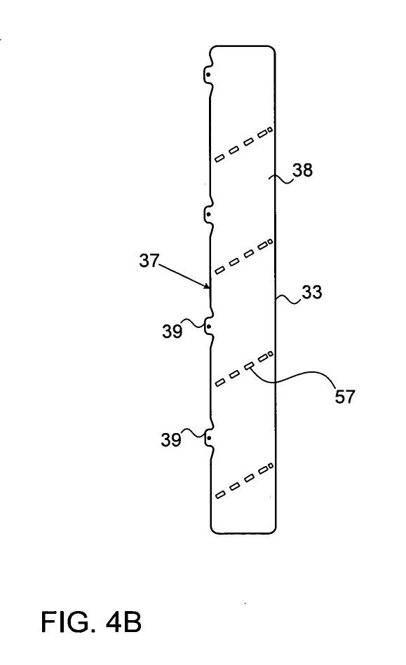

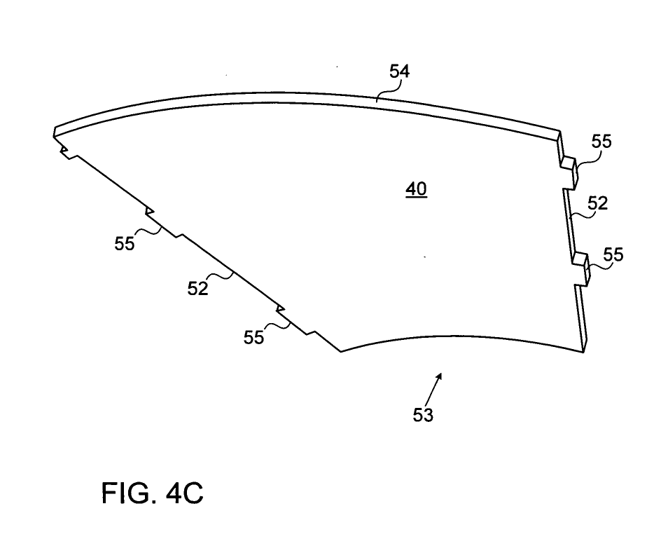

Preferably, for ease of assembly, the relatively complex structure of the display device 50 shown in FIG. 3 is fabricated from a small number of interconnecting, easily fabricated parts. Thus with reference to FIG. 4A, the central drum may be fabricated from a cylinder of aluminum or other material, either extruded through a die, or fabricated by rolling up a sheet and welding or riveting the seam. The apertures therewithin may be cut away with standard drilling or milling machinery. Drum 46 is typically a tube of a material that is preferably rustproof, lightweight and attractive, such as Aluminum which may be highly polished, or anodized in a range of colors. Drum 46 may alternatively be fabricated from stainless steel or from a polymer. A plurality of apertures 30 is provided around drum 46. Preferably apertures 46 are arranged in rows A-D.

As shown in FIG. 4B, the vertical wall elements of the niches may be fabricated as a rectangular strip and as shown in FIG. 4C, the shelf elements 40 of the niches 24 may be segment shape plates with substantially straight outer edges 52 for engaging the vertical wall element pieces 38 (FIG. 4b), and typically arcuate inner 53 and outer edges 54 for engaging the drum 36 and coming into close proximity, but not touching the display case 12. For ease of assembly, slots 47 may be cut into the drum 36 and the inner edge 37 of the vertical wall element pieces 38 may be fabricated with protruding tabs 39 for engaging the slots 47 in the drum 36. Similarly, slots 57 may be machined out of the vertical side wall elements 38 for engaging tabs 55 protruding from the base pieces 40.

As described hereinabove, preferably when the display device 50 is assembled and the drum 36 is aligned vertically, the shelf elements 40 slope outwards and upwards, so the slots 57 in the vertical wall elements 38 for engaging the tabs 55 of the shelf elements 40 will be angled to the long edges 33, 37 of the vertical wall elements 38, typically at an angle of between 30° and 60°, most preferably about 45° thereto. It will be appreciated that in embodiments of the display device having a plurality of rows of niches A-D, the angle of the shelf elements 40 in different rows may vary, as may the separation between base shelf element and top shelf element of each row of niches A-D and the shapes of the apertures 30 at the rear of the niches 26. In this manner, the different rows A-D may be configured to accept short and long stem bouquets and to vary the display angle thereof—it being appreciated that generally the lower rows C, D will be below eye level and the purchaser will be looking downwards thereinto.

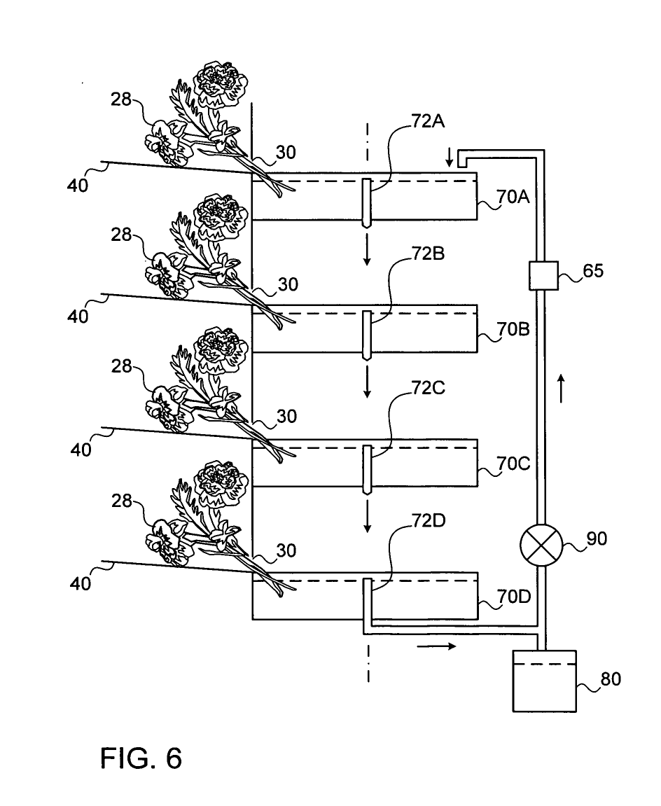

Referring now to FIG. 6, there is shown display device 50 in a schematic cross-sectional partial side view showing shelf elements 40, apertures 30, and nutrient containers 70A-70D arranged immediately therebelow, and supported within the interior space of the drum 46 (not shown). As seen, the shelf elements 40, apertures 30 and nutrient containers 70A-70D are mutually arranged such that bouquets of flowers 28 supported within niches 14 (FIG. 1), reside on shelf elements 40 such that the cut ends of the flowers are immersed within liquid nutrient within containers 70A-70D.

As shown, containers 70A-70D preferably have drainage tubes 72A-72D for preventing their respective associated containers from overflowing, and for facilitating circulation of a liquid. Preferably, each of tubes 72A-72D is height adjustable, so as to correspondingly adjust the depth of the liquid within each container.

As seen in the drawings, there is provided a suitable pump 90 for circulating the aqueous liquid 65 from the bottom container 70D and, optionally, an additional reservoir 80, to the top of the display device into the upper container 70A associated with the first row A of niches 24. As container 70A fills up to the level of the tube 72A, water can cascade through the tube 72A and down into the container 70B there-beneath. Optionally, in order to prevent splashes, the tube 72A may be long enough so that its lower end is below the mouth of tube 72B in the container 70B therebeneath. Tube 72B prevents too much aqueous liquid accumulating in container 70B and allows excess to flow into container 70C therebeneath, with tube 72C performing a similar function with respect to container 70C. The overflow from the container 70D may be immediately recirculated by pump 90, and may feed into reservoir 80, as required. Optionally, a filter 65 is provided for filtering the water. The filter 65 may be a charcoal or gravel filter, or a gauze type filter. The aqueous fluid may be simply water, perhaps tap water, but may contain metal ions, particularly Copper and silver ions, selective algaecides fertilizers, sugars, flower food and other additives. For example, adding aspirin and lemonade to water is good for roses. A general purpose flower food might contain 1 teaspoon of bleach, 1 teaspoon of vinegar, 2 teaspoons of sugar for every 1 liter of room temperature water.

In contradistinction to prior art flower vending machines of where water for the individual bouquets is visible to customers, it is a particular feature of embodiments of the invention that the aqueous fluid is contained within containers 70A-70D which are concealed from sight, within drum 36. Moreover, in view of the fact that container 70A-70D are concealed and apertures 30 are relatively small, the amount of evaporation within the display case 12 is reduced relative to the prior art, thereby reducing the amount of moisture within the atmosphere of the display case.

A vending machine for vending bouquets only will typically have three or four rows of niches, and these will rotate together to display all bouquets in turn, from different viewing angles. Vending machines could sell other items as well, using some of the niches for chocolates, cuddly toys, ornaments, clothing, jewelry, accessories or other gifts. Such other items may be displayed in the sloping niches with apertures designed for blooms, or may be provided with niches more appropriate for these other items. Thus the display case may only provide one row of niches for cut flowers.

The vending machine 10 includes means for selecting the contents of a particular niche and aligning it with a port for vending. Preferably, display cabinet 12 is thermostatically controlled to keep flowers at optimum temperature, and will typically include refrigerator circuits, perhaps heater circuits for use in cold surroundings, and internal lighting.

The scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not to the exclusion of other components unless otherwise stated.

We claim:

1. A display device for displaying cut flowers within a transparent display case, the display device being pivotally mounted with respect to the case, to allow the drum to rotate about it's axis with respect to the display case; the display device comprising a drum having a first row of apertures therearound and a container for an aqueous liquid therewithin, below the first row of apertures so that cut ends of cut flowers passing through said apertures are insertable into the container to slant upwards and outwards towards the display case.

2. The display device of claim 1, wherein the drum further comprises at least one additional row of apertures and associated container for displaying cut flowers in a plurality of TOWS.

3. The display device of claim 1 wherein the display case comprises a window comprising a material selected from the list of silica glass and glassy thermoplastics.

4. The display device of claim 1, comprising a plurality of display niches arranged about the drum, within the display case, each niche having an aperture associated therewith, so that at least one cut flower can be positioned within each niche and, so that stem passes through aperture into container, and head of at said at least one cut flower is viewable through the display case.

5. The display device of claim 4, wherein vertical side wall elements of said niches are arranged radially around the drum.

6. The display device of claim 4 wherein bases of said niches are shelf elements that slope outwards and upwards from the drum.

7. The display device of claim 1 further comprising a circulating system for circulating the aqueous liquid.

8. The display device of claim 7 wherein the circulating system comprises a reservoir at base of the display device, a pump for pumping fluid from the reservoir to the uppermost container via a conduit, and overflow pipes coupled to each container, for maintaining the liquid level in each container, and diverting excess liquid to container therebeneath.

9. A vending machine comprising the display device of claim 1 within the display case and further comprising a port associated with each row of niches for accessing niches within each row for removing vendible goods thereby.

10. The vending machine of claim 9, wherein said ports comprise selectively lockable doors to prevent access to contents of the niches.

11. The vending machine of claim 9 further comprising a user interface for selecting a niche to bring said niche into alignment with a port for extraction of contents thereby.

12. The vending machine of claim 11 wherein the user interface further comprises a payment means and allows selection of a niche only after making a payment.

13. The vending machine of claim 12 wherein the payment means being selected from the group comprising a credit card reader and a cash depositing system.

14. The vending machine of claim 12 wherein the interface comprises an alphanumeric keypad for keying in data.

15. The vending machine of claim 11 wherein the interface comprises a screen for displaying data to user.
